(19) United States
(12) Patent Application Publication
(10) Pub. No.: US 2022/0309383 A1
(43) Pub. Date: Sep. 29, 2022

(54) LEARNING OF OPERATOR FOR PLANNING PROBLEM

(71) Applicant: International Business Machines Corporation, Armonk, NY (US)

(72) Inventors: CORENTIN JACQUES ANDRE SAUTIER, Groslay (FR); DON JOVEN RAVOY AGRAVANTE, Tokyo (JP); Michiaki Tatsubori, Oiso (JP)

(21) Appl. No.: 17/210,891

(22) Filed: Mar. 24, 2021

(51) Int. Cl. G06N 20/00; G06K 9/62; G06N 5/04

(52) U.S. Cl. CPC G06N 20/00; G06K 9/6232; G06N 5/04; G06K 9/6257; G06K 9/6262

(57) ABSTRACT

A method for inferring an operator including a precondition and an effect of the operator for a planning problem is disclosed. In the method, a set of examples, each of which includes a base state, an action and a next state after performing the action in the base state is prepared. In the method, variable lifting is performed in relation to the set of examples. In the method, a validity label is computed for each example in the set of examples. In the method, a model is trained by using the set of examples with the validity label so that the model is configured to receive an input state and a representation of an input action and output at least validity of the input action for the input state. In the method, the precondition of the operator based on the model and the effect of the operator are outputted.

### STATEMENT REGARDING PRIOR DISCLOSURES BY THE INVENTOR OR A JOINT INVENTOR

The following disclosure(s) are submitted under 35 U.S.C. 102(b)(1)(A):

‘Grace period disclosures’ were made public on Dec. 3, 2020, less than one year before the filing date of the present U.S. patent application. The oral presentation and the publication were entitled ‘Towards Logical Model-based Reinforcement Learning: Lifted Operator Models’ and the joint authors of these oral presentation and publication were Corentin Sautier, Don Joven Agravante, Michiaki Tatsubori, who are also named as joint-inventors of the invention described and claimed in the present patent U.S. application. This oral presentation was held virtually on 7 Jan. 2021 and the publication was published at the official website for the Knowledge Based Reinforcement Learning (KBRL) Workshop at IJCAI-PRICAI 2020, Yokohama, Japan. (https://kbrl.github.io/schedule/) on Dec. 3, 2020.

### BACKGROUND

The present invention relates generally to the field of machine learning, and more particularly to a computer-implemented method, a computer system and a computer program product for inferring an operator for a planning problem.

Reinforcement learning is the machine learning paradigm where an agent learns the best way to interact with an environment by taking actions and observing the results of the actions. Recent research has shifted to deep learning with model-based reinforcement learning in order to improve data efficiency. The philosophy of the approach is to first learn a model of the environment dynamics and then to plan over this model. The model-based reinforcement learning has produced significant state-of-the-art results in recent years. However, current models are still opaque and difficult to integrate with external knowledge bases.

Planning problem is a task of generating action sequences for execution by an agent that is guaranteed to generate a state containing desired goals. In the planning problem, once an operator, which is a definition of action's preconditions and effects, is defined, a problem can be solved in a variety of application area, by using planners. Note that an action must meet a precondition to be considered valid and its application has an effect that modifies the state of the environment. Currently, operators are manually handcrafted by experts.

### SUMMARY

According to an embodiment of the present invention, a computer-implemented method for inferring an operator including a precondition and an effect of the operator for a planning problem is provided. The method includes preparing a set of examples, each of which includes a base state, an action and a next state after performing the action in the base state. The method also includes performing variable lifting in relation to the set of examples. The method further includes computing a validity label for each example in the set of examples. The method also includes further training a model that is configured to receive an input state, a representation of an input action, and output at least validity of the input action for the input state, by using the set of examples with the validity label. Further the method includes outputting the precondition of the operator based on the model and outputting the effect of the operator.

The method according to the embodiment of the present invention enables inferring the operator for the planning problem from the set of examples including the results of performing the actions even in the presence of noise in the observed state.

According to other embodiment of the present invention, a computer system for inferring an operator including a precondition and an effect of the operator for a planning problem is provided. The computer system includes a processor and a memory coupled to the processor. The processor is configured to prepare a set of examples, each of which includes a base state, an action and a next state after performing the action in the base state. The processor is also configured to perform variable lifting in relation to the set of examples. The processor is further configured to compute a validity label for each example in the set of examples. The processor is configured to further train a model that is configured to receive an input state, a representation of an input action and output at least validity of the input action for the input state, by using the set of examples with the validity label. Further the processor is configured to output the precondition of the operator based on the model and output the effect of the operator.

The computer system according to the embodiment of the present invention enables inferring the operator for the planning problem from the set of examples including the results of performing the actions even in the presence of noise in the observed state.

According to another embodiment of the present invention, a computer program product for inferring an operator including a precondition and an effect of the operator for a planning problem is provided. The computer program product includes a computer readable storage medium having program instructions embodied therewith. The program instructions are executable by a computer to cause the computer to perform a method. The method includes preparing a set of examples, each of which includes a base state, an action and a next state after performing the action in the base state. The method also includes performing variable lifting in relation to the set of examples. The method further includes computing a validity label for each example in the set of examples. The method also further includes training a model that is configured to receive an input state and a representation of an input action and output at least validity of the input action for the input state, by using the set of examples with the validity label. Further the method includes outputting the precondition of the operator based on the model and outputting the effect of the operator.

The computer program product according to the embodiment of the present invention enables inferring the operator for the planning problem from the set of examples including the results of performing the actions even in the presence of noise in the observed state.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 (i.e., FIG.) shows a schematic of a framework and a problem setting for a reinforcement learning system implementing an operator learning module according to an exemplary embodiment of the present invention;

FIG. 2 illustrates schematics of training and testing agents used in a reinforcement learning system according to an exemplary embodiment of the present invention;

FIG. 3 illustrates a schematic of an operator learning module in a training agent used in a reinforcement learning system according to an exemplary embodiment of the present invention;

FIG. 4 describes a schematic of the problem ‘Tower of Hanoi’ problem, which is a simple example widely used in the area of the reinforcement learning;

FIG. 5 describes a schematic of an operator definition of the problem ‘Tower of Hanoi’ in a PDDL format;

FIG. 6 describes schematics of examples of initial and goal states in the problem ‘Tower of Hanoi’;

FIG. 7 illustrates a schematic of variable lifting that converts a grounded state representation into a lifted state representation (in the problem ‘Tower of Hanoi’) in a reinforcement learning system according to an exemplary embodiment of the present invention;

FIG. 8 illustrates examples of variable lifting to a pair of a state and an action according to the exemplary embodiment of the present invention;

FIG. 9 shows a flowchart of a process for inferring a lifted operator for a planning problem according to an exemplary embodiment of the present invention;

FIG. 10 illustrates a schematic of a way of computing one or more effect labels with variable lifting according to an exemplary embodiment of the present invention;

FIG. 11 illustrates an example architecture of a model trained by a process for inferring a lifted operator according to an exemplary embodiment of the present invention;

FIG. 12 illustrates a schematic of a precondition of an operator in a lifted representation in the problem ‘Tower of Hanoi’;

FIG. 13 illustrates examples of valid and invalid action in the problem ‘Tower of Hanoi’ in a PDDL format;

FIG. 14 illustrates pseudo-code for computing validity label, pseudo-code for computing effect labels and pseudo-code for calculating feature importance to obtain preconditions of an operator in a reinforcement learning system according to an exemplary embodiment of the present invention;

FIG. 15 illustrates a schematic of overall flow to obtain a precondition and an effect of an operator from a set of training examples in a reinforcement learning system according to an exemplary embodiment of the present invention;

FIG. 16 illustrates a schematic of an operator learning module in a training agent used in a reinforcement learning system according to other exemplary embodiment of the present invention;

FIG. 17 shows a graph indicating evolution of Grounded and Lifted F1 score with noise; and

FIG. 18 depicts a schematic of a computer system according to one or more embodiments of the present invention.

### DETAILED DESCRIPTION

Hereinafter, the present invention will be described with respect to particular embodiments, but it will be understood by those skilled in the art that the embodiments described below are mentioned only by way of examples and are not intended to limit the scope of the present invention.

One or more embodiments according to the present invention are directed to a computer-implemented method, a computer system and a computer program product for inferring an operator for a planning problem. In one or more embodiments, the computed operator may be used by a planner (e.g., a PDDL (Planning Domain Definition Language) planner) and the planner may be used for solving the planning problem or may be used by an agent in a model-based reinforcement learning framework where the agent takes an action inferred by the planner and obtains a state generated by a semantic parser that converts raw observations from the environment into the state in a logical form.

In one or more embodiments, the operator includes a precondition that needs to be valid to execute an action of the operator and an effect of changing state when the action of the operator is executed. The precondition and the effect may be written in a predicate logic language. In a particular embodiment, the operator has an operator predicate (e.g., move) and one or more parameters (e.g., a, b, c). Note that the operator is lifted and becomes an action (e.g., move (disc1, disc2, peg3)) once the one or more parameters are grounded on one or more actual objects (e.g., disc1, disc2, peg3). The precondition of the operator may include a list of lifted propositions to be valid to perform an action of the operator (e.g., (smaller ?c?a), (on ?a?b), . . . ). The effect of the operator includes a list of changes for each possible proposition in a lifted state after performing the action of the operator (e.g., (clear ?b), (NOT (on ?a?b)), . . . ). Note that the number of operators to be inferred is not limited to one, a plurality of operators each including a precondition and an effect may be computed.

In one or more embodiments, the computer-implemented method may include at least one of preparing a set of examples (D={(s, a, s′)}) each including a base state (s), an action (a) and a next state (s) after performing the action (a) in the base state(s); performing variable lifting (e.g., replacing an actual object (e.g., disc1) with an abstract variable (e.g., v1)) in relation to the set of examples (D); computing a validity label (e.g. valid or invalid) for each example (e.g., (s, a)) in the set of examples (D); training a model (e.g., a neural network, a logistic regression, etc.) that is configured to receive an input state (e.g. Boolean value of every possible proposition for the lifted, grounded or mixed state) and a representation of an input action (e.g. a one-hot encoding of the operator) and output at least validity (e.g. [0,1]) of the input action for the input state, by using the set of examples (D) with the validity label; outputting the precondition of the operator (e.g., a PDDL precondition) based on the model; and outputting the effect of the operator (e.g., a PDDL effect).

In a particular embodiment, preparing the set of examples (D={(s, a, s′)}) includes interacting with an environment (E) by taking the action (a) in the base state (s) and receiving a result of the action to obtain the next state (s′) in a manner based on an exploration policy (π(a s)).

In a preferable embodiment, the method further includes computing, based on the model, importance (e.g., feature importance score) of each lifted proposition (p∈P; p is a member of a set of possible propositions P for the lifted state) relating to a state; and enumerating a list of lifted propositions (e.g., on (v1, v2), clear (v1), . . . ) satisfying criteria (e.g., thresholding) with respect to the importance as the precondition of the operator. In a particular embodiment, computing the importance of each lifted proposition (p) includes: generating a test state (s″) based on the base state by flipping the lifted proposition (e.g., s″=s−p if p is in s, and s+p if p is not in s); calculating validity of the action for the base state (e.g., predict (s, a)) and the test state (e.g., predict(s″, a)); and scoring the lifted proposition (p) by comparing the validity between the base state and the test state (e.g. distance (predict (s,a), predict (s″, a))).

In a particular embodiment, training the model includes computing one or more effect labels for each valid example in the set of examples (D); and training the model jointly with the validity as a target for a first output and an effect vector as a target for a second output by using further the one or more effect labels for each valid example. Each element in the effect vector indicates whether a corresponding lifted proposition changes (e.g., becomes true or false) or not (e.g., does not change). The effect of the operator may be calculated by using the model.

In other particular embodiment, the method includes computing one or more effect labels for each valid example in the set of examples (D). The method also includes training a second model that is configured to receive the input state and the representation of the input action and output an effect vector, by using the set of examples with the one or more effect labels. Each element in the effect vector indicates whether a corresponding lifted proposition changes (e.g., becomes true or false) or not (e.g., does not change). The effect of the operator may be calculated by using the second model.

In further other particular embodiment, outputting the effect of the operator includes calculating one or more effect labels for each valid example in the set of examples (D). Outputting the effect further includes calculating a statistic (e.g., average) of each of the one or more effect labels over the valid examples in the set of examples (D) to obtain the effect of the operator.

In a particular embodiment, performing variable lifting includes obtaining the one or more objects (e.g., disc1, disc2, peg3) in the action for each example in the set of examples (D); discarding one or more state propositions relating to an object other than the one or more objects of the action (e.g., discarding clear (peg2)); and replacing each object (e.g., disc1, disc2, peg3) in each remaining state proposition with an abstract variable (e.g. v1, v2, v3) corresponding one of the one or more parameters (e.g., a, b, c) of the operator. Note that the state before the variable lifting may be defined as a conjunction of every proposition grounded on actual objects (e.g., clear (disc1), clear (peg2), clear (peg3), on (disc1, disc2), on (disc2, disc3) . . . ). The state after the variable lifting may be defined as a conjunction of every proposition that is lifted from actual objects and related to merely the one or more objects in the action (e.g., clear (v1), clear (v3), on (v1, v2) . . . ).

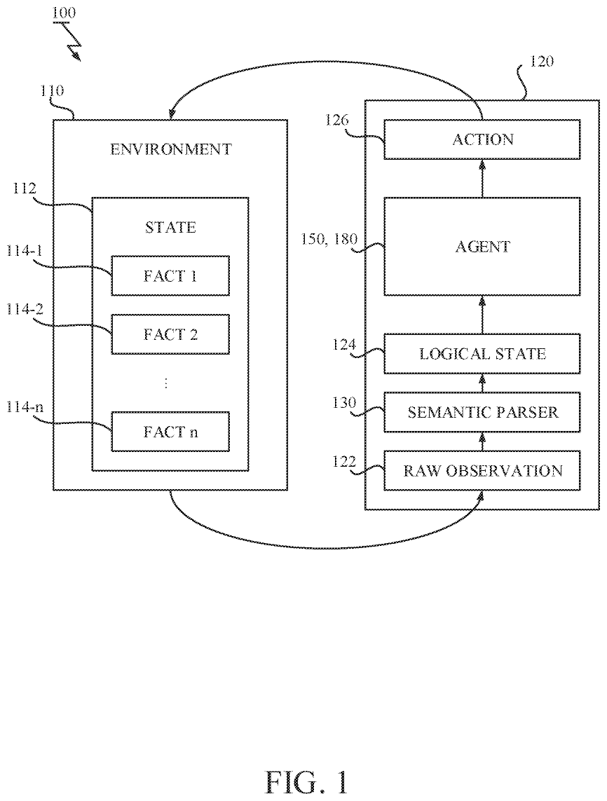

Hereinbelow, referring to a series of FIGS. 1-15, a computer-implemented method, a computer system and a computer program product for inferring an operator for a planning problem according to an exemplary embodiment will be described. Implementation of embodiments of the invention may take a variety of forms, and exemplary implementation details are discussed subsequently with reference to the Figures.

The present invention will now be described in detail with reference to the Figures.

With reference to FIG. 1, a schematic of a framework and a problem setting for a reinforcement learning system according to an exemplary embodiment of the present invention is described. The reinforcement learning system 120 according to the exemplary embodiment implements a mechanism (an operator learning module) for inferring, computing and/or learning a lifted operator, which can be used by a planner built in an agent of the reinforcement learning.

As shown in FIG. 1, there is an environment 110 where an agent of the reinforcement learning system 120 works. As shown in FIG. 1, the environment 110 has a state 112 that can be sufficiently approximated as a set of logical facts 114-1˜114-n where n is the number of logical facts 114. The environment 110 represents a task or simulation which needs to be solved by the agent of the reinforcement learning system 120.

For instance, in the case of conversational agents/chatbots, the environment may be the human customers asking for technical assistance. In the case of robotic arm manipulation, the agent may be a controller of a robotic arm and the environment may be an entire system including the robotic arm and its surroundings such as workpieces and obstacle. In the case of autonomous driving, the agent may be a driver of an automobile and the environment 110 may be an entire system including the automobile and its surroundings such as roads, obstacle, etc. Examples of the environment is not limited and includes any environment that can be a target of the reinforcement learning in the technology field.

The reinforcement learning system 120 shown in FIG. 1 includes further a semantic parser 130 in addition to the agent. The agent obtains an observation of the environment 110 through the semantic parser 130. The observation inputted to the reinforcement learning system 120 is referred to as a raw observation 122. Examples of the raw observation 122 may include, but is not limited to, images, texts, sensor outputs, and the like, which can be obtained from the environment 110 by using an appropriate interface and/or devices.

For instance, in the case of conversational agents/chatbots, raw observations are a natural language description of the technical problem. In the case of robotic arm manipulation, the raw observation 122 may include signals from sensors such as torque meters and encoders, to name but a few. In the case of the autonomous driving, the raw observation 122 may include indicators of a speed meter and other instruments, images taken with an in-vehicle camera and/or signals from sensors.

The semantic parser 130 converts the raw observation 122 into a logical form, that is referred to as a logical state 124. The semantic parser 130 implements a method for converting a human-readable representation to a machine-readable format. The semantic parser 130 may include a neural network that may be trained for handling a specific application in deep learning methodology for instance. Note that, in general, the semantic parser 130 works good but may not be perfect, hence the semantic parser 130 may generate a noisy representation of the real state, meaning that the noisy state may or may not contain one or more wrong states.

The agent obtains the logical state 124 from the environment 110 via the semantic parser 130 and takes an action 126 based on a policy, which is an action selection rule for the agent. Examples of the action 126 may include, but are not limited to, any control parameters, which can be submitted to the environment 110 by using an appropriate interface and/or devices.

For instance, in the case of conversational agents/chatbots, the agent needs to output a series of intervention actions to recommend to the human. In the case of the robotic arm manipulation, the action may include parameters for control actuators in the robotic arm, to name but a few. In the case of the autonomous driving, the action may include depressing a brake pedal, depressing an accelerator pedal, steering a steering wheel, etc.

In FIG. 1, the agent has two numerals assigned thereto: one is 150 for representing an agent that learns the operator by interacting with the environment 110 and other is 180 for representing an agent that tries to solve the task of the environment 110 by using the learned operator.

The present invention may contain various accessible data sources, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. The present invention provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed The present invention enables the authorized and secure processing of user information, such as tracking information, as well as personal data, such as personally identifying information or sensitive personal information. The present invention provides information regarding the personal data and the nature (e.g., type, scope, purpose, duration, etc.) of the processing. The present invention provides the user with copies of stored personal data. The present invention allows the correction or completion of incorrect or incomplete personal data. The present invention allows the immediate deletion of personal data.

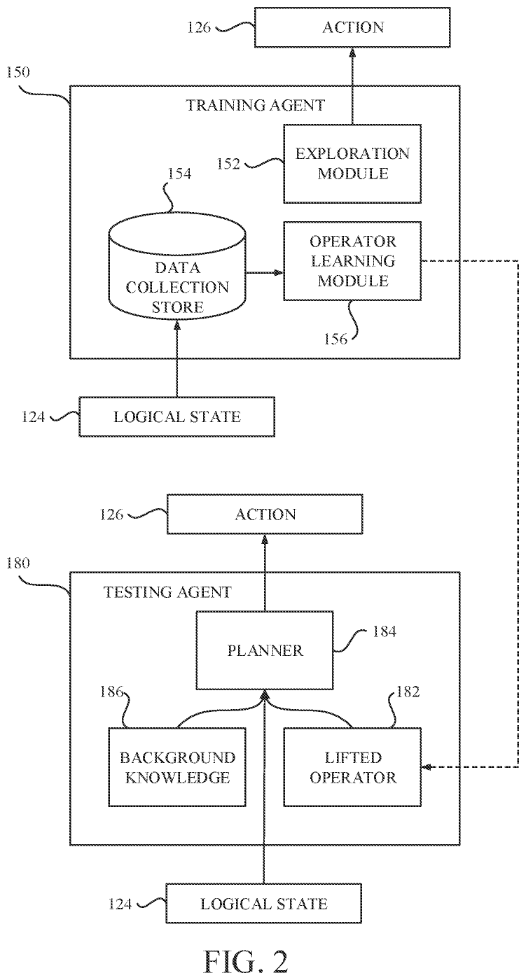

With reference to FIG. 2, schematics of training and testing agents used in the reinforcement learning system according to the exemplary embodiment of the present invention are described. In the reinforcement learning system 120 according to the exemplary embodiment, there is two agents including a training agent 150 and a testing agent 180.

The training agent 150 is configured to collect training examples and learn the best way to interact with the environment 110 by taking the action 126 and observing the result of the action 126, which is observed as the raw observation 122 and then converted into the logical state 124 by the semantic parser 130. The task of the training agent 150 is to learn from the logical state 124 with a noise and produce a model for selecting good action in the environment 110.

The training agent 150 may include an exploration module 152, a data collection store 154 and an operator learning module 156.

The exploration module 152 is configured to explore action and state spaces in the environment 110 and prepare a set of training examples. The set of training examples may be acquired by repeatedly taking an action in a current state and observing a resultant state after the action in a manner based on an exploration policy. Examples of the exploration policy may include, but is not limited to, a random policy, a learned policy based on past learning results and a combination thereof. Each training example in the set may include an action (a), a base state (s; a state before an action) and a next state (s′; a state after performing the action in the base state (s)). As described above, the state observed by the exploration module 152 may include a noise due to the nature of the semantic parser 130.

The data collection store 154 is configured to store the set of training examples that are collected by the exploration module 152. The data collection store 154 is provided by any internal or external storage (e.g., memory, persistence storage) in a computer system.

The operator learning module 156 is configured to perform operator learning to infer a lifted operator 182 for the environment 110, which will be used by the testing agent 180. The operator learning module 156 will be described in more detail later.

The testing agent 180 is configured to execute actions in the environment 110 in a manner based on the learned knowledge, especially the lifted operator 182 learned by the operator learning module 156 of the training agent 150.

The testing agent 180 may include the lifted operator 182 provided by the training agent 150 and a planner 184, which can solve a planning problem described by an appropriate planning language such as PDDL. The lifted operator 182 is generated by the operator learning module 156 in an appropriate format (e.g., PDDL format), so the planner 184 can process the lifted operator 182. The planner 184 plans over the lifted operator 182 and generate a sequence of actions based on the lifted operator 182.

In a particular embodiment, the testing agent 180 may further include background knowledge 186 and the planner 184 utilizes the background knowledge 186 in combination with the learned lifted operator 182 to take the action 126. The background knowledge 186 may include any given knowledge about the environment 110. For example, the background knowledge 186 may be in the form of a set of constant propositions that should appear in the states or a partially specified operator model that can then be combined with the learned operator models. Having this logical representation of the state provides an insertion point for external knowledge.

Since the training agent 150 takes noisy logical states as input by interacting with the environment 110, the system is at the intersection of the model-based reinforcement learning and the planning problem. The framework shown in FIG. 1 and FIG. 2 is a two-stage process where the semantic parser 130 converts the raw observation 122 into the noisy logical state 124 and the training agent 150 learns from the noisy logical state 124 to generate the lifted operator 182. This approach is to formulate the learned model as lifted operators of the planning problem, thereby allowing us to use the planner 184 that can provide guarantees about consistency, safety and optimality.

The reinforcement learning system 120 according to the exemplary embodiment of the present invention can be said as a model-based reinforcement learning system since the transition dynamics of the environment 110 is modeled as the lifted operator 182 for the planning problem. Also, the reinforcement learning system 120 is said as a relational reinforcement learning system since the states and the actions have ‘relational’ representations (i.e., predicate logic).

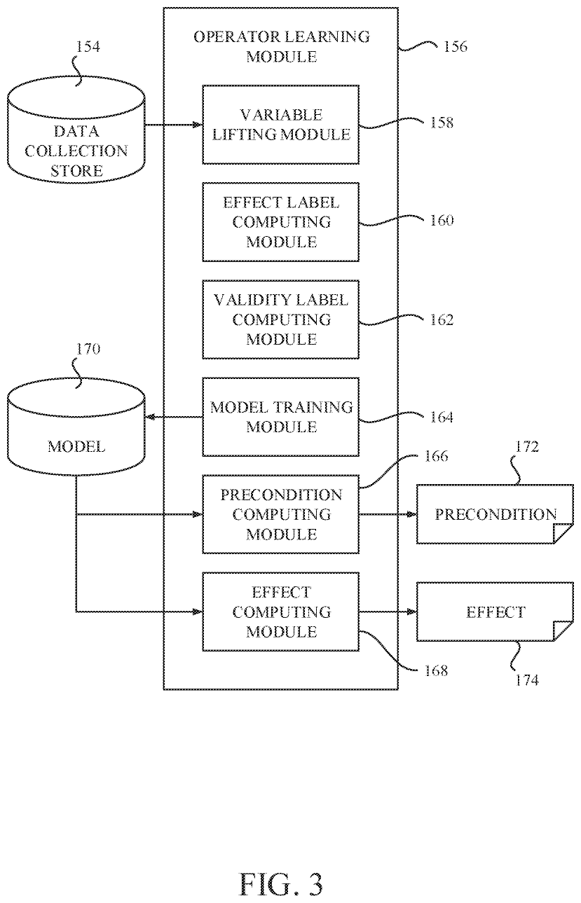

With reference to FIG. 3, a schematic of the operator learning module 156 in the training agent 150 according to the exemplary embodiment of the present invention is described. The operator learning module 156 shown in FIG. 3 may include a variable lifting module 158; an effect label computing module 160; a validity label computing module 162; a model training module 164 for training a model 170; a precondition computing module 166 for computing the precondition based on the trained model 170; and an effect computing module 168 for computing the effect based on the trained model 170.

The operator learning module 156 is configured to output a lifted operator based on the set of training examples stored in the data collection store 154. The operator learned by the operator learning module 156 may include a single operator or a plurality of individual operators. The number of operators to be learned may depend on the specific of the environment 110. Each operator may have an operator predicate and one or more parameters and may be consist of a precondition 172 and an effect 174. The precondition 172 may include a list of lifted propositions to be valid for execution of an action of the operator. The effect 174 includes a list of changes in a lifted state after performing an action of the operator. The precondition and the effect of the operator are used by the planner 184. Outputting the lifted operator includes any form of outputting and may include saving the data of the lifted operator to a storage medium, sending the data of the lifted operator to other component, displaying the lifted operator on a display device, and/or printing the data of the lifted operator from the printer, etc.

Hereinbelow, before describing each module in the operator learning module 156, the problem setting, and formulation will be described in more detail. Consider a deterministic environment E that is based on an internal logic state z (z∈S; the internal logical state z is a member of the set of internal logical states S) or can be approximated as such. Here, the logical state is defined to have a predicate function grounded on some objects. For example, a logical state ‘on (disc1, peg1)’ is a proposition composed of the predicate ‘on’, grounded on the two objects ‘disc1’ and ‘peg1’. The full logical state of the environment E is defined as a conjunction of Boolean value of every proposition at a given time.

Note that in the described embodiment the basic reinforcement learning problem setting where the agent interacts with environment E by performing the actions a (a∈A; the action a is a member of the set of possible actions A), based on the observation o (o∈O; the observation o is a member of the set of possible observations O) is kept. The environment E transitions the state based on the action taken such that the dynamics of the next state is determined according to z′=T(z, a).

Two particularities of the problem setting are now added onto the base setting. First, it is assumed that the semantic parser 130 is good but imperfect and produces approximates of the state s from the observation o, that is s=φ(o). Second, the environment dynamics T can be re-formulated as a planning operator with a precondition and an effect. The operator learning module 156 learns the model (i.e., the lifted operator) from the set of training examples (s, a, s′) ((s, a, s′)∈S×A×S; the training example (s, a, s′) is a member of a product of sets S×A×S). Note that the training agent 150 can only collect the approximates of the state s instead of the actual internal state z.

A training example is valid if the internal state z respects the preconditions of the action a, and from the application of the effects the stage z becomes z′ (z is not equal to z′). By extension, valid actions relative to the validity can be defined. In the well-known problem ‘Tower of Hanoi’ for instance (hereinafter, for the purpose of convenience, the embodiment will be described assuming that the task of the environment E is the problem ‘Tower of Hanoi’, which is a simple example widely employed in the area of the reinforcement learning), trying to place a large disc on a smaller disc would be an invalid action and this action does not change any states.

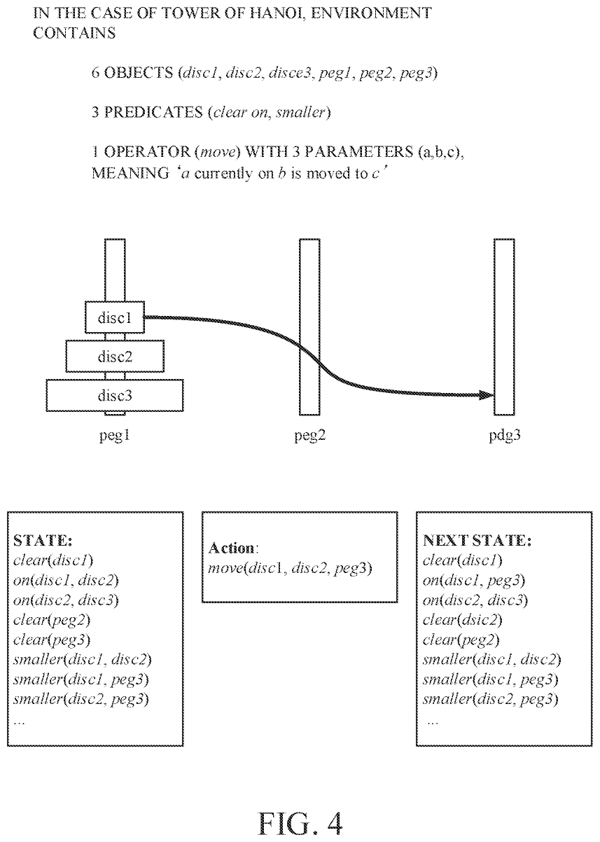

FIG. 4 describes the problem ‘Tower of Hanoi’. In the case of the problem ‘Tower of Hanoi’, the environment E contains six objects, three predicates and one operator. The objects include three discs (‘disc1’, ‘disc2’, ‘disc3’) and three pegs (‘peg1’, ‘peg2’, ‘peg3). The predicates include ‘clear’, ‘on’ and ‘smaller’. For instance, a proposition ‘on (disc1, disc2)’ is true if the object ‘disc1’ is on the object ‘disc2’. A proposition ‘clear (disc1)’ is true if the object disc1 is at the top. A proposition ‘smaller (disc1’, disc2)’ is true if the object ‘disc1’ is smaller than the object ‘disc2’.

The operator of the problem ‘Tower of Hanoi’ includes an operator ‘move’ having three parameters (a, b, c). The ‘move’ operator is an instruction directing to move an object designated by the first arity a currently on an object designated by the second arity b to an object designated by the third arity c. An action is composed of an operator predicate, grounded on objects. The operator is an abstract representation of every possible action. For example, the action ‘move (disc1, disc2, peg3)’ instructs to move the object ‘disc1’ currently on the object ‘disc2’ to the object ‘peg3’ as exemplary illustrated in the middle of FIG. 4.

The state of the environment E is defined as a conjunction of (Boolean value of) every proposition grounded on actual objects as shown in FIG. 4 (In the bottom of FIG. 4, merely true statements are shown). By performing the action ‘move (disc1, disc2, peg3)’, the state proposition ‘on (disc1, disc2)’ becomes ‘False’ and the state proposition ‘on (disc1, peg3)’ becomes ‘True’. Also, the state proposition ‘clear (peg3)’ becomes ‘False’ and the state proposition ‘clear (disc2)’ becomes ‘True’.

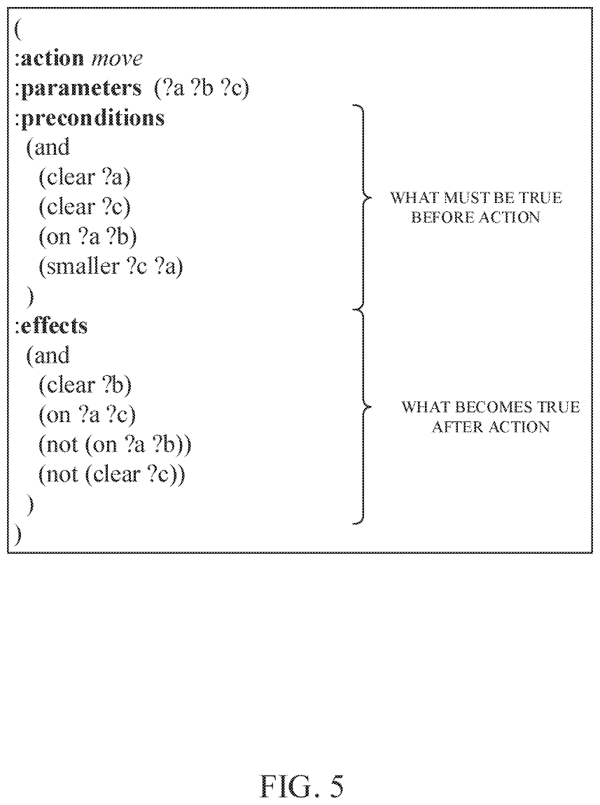

The operator includes the information about the precondition and the effect. In the case of the problem ‘Tower of Hanoi’, as mentioned above, only a single operator ‘move’ with three parameters is defined in PDDL formatting. FIG. 5 describes a schematic of an operator definition of the problem ‘Tower of Hanoi’ in a PDDL format. The operator ‘move’ defines 3 parameters (:parameter (?a?b?c)), whose state must match a list of lifted propositions in the preconditions to consider the action valid (:preconditions (and (clear ?a) . . . )) and will be affected by the effects in the state following the action (:effects (and (clear ?b) . . . )). The operators can fully define all state transitions in the environment E.

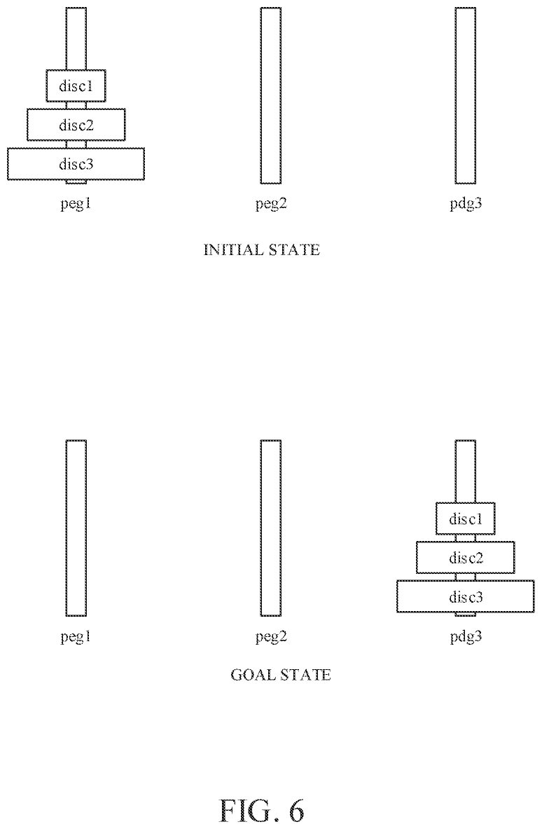

In PDDL two files including a domain file for predicates and operators (including the precondition and the effect) and a problem file for objects, an initial state and a goal specification, are used. Hence, follow the PDDL planning formulation, an initial state si and a goal state s_{g} (si, s_{g}∈S; the initial state s_{g} and the goal state s_{g} are members of the set of possible state S) may be required with the operators for PDDL planner. FIG. 6 describes schematics of examples of initial and goal states in the problem ‘Tower of Hanoi’. Once the operators are learned from the set of training examples (D={(s, a, s′)}), the testing agent 180 can plan over the lifted operator model to produce a sequence of actions from the initial state si to the goal state s_{g}.

Hereinbelow, although the environment 110 represents a task of some real world problems such as the conversational agents/chatbots, the robotic arm manipulation, and the autonomous driving tasks, for the purpose of convenience, the task of the environment 110 is assumed to be the problem ‘Tower of Hanoi’. Hence, the main task of the operator learning module 156 is described to learn an equivalent representation of the operator of the problem ‘Tower of Hanoi’ from the set of training examples D acquired by interacting with the environment E that implements the problem ‘Tower of Hanoi’. Also note that in the real world problem the state, which is handcrafted in the case of the problem ‘Tower of Hanoi’ as shown in FIG. 4, could come from the semantic parser 130 in the reinforcement learning system 120. It is assumed that the initial state is sufficiently good. As for the goal state, although it is possible to relate the goal state to the reward function, it may be assumed that the goal state is specified beforehand.

Referring again to FIG. 3, the modules of the operator learning module 156 will be described in more detail. The operator learning module 156 shown in FIG. 3 may include the variable lifting module 158. The variable lifting module 158 may be configured to perform variable lifting in relation to the set of training examples D collected by the training agent 150. The state in each training example may be defined as a conjunction of Boolean value of every proposition grounded on actual objects, thus, the state is said to be grounded.

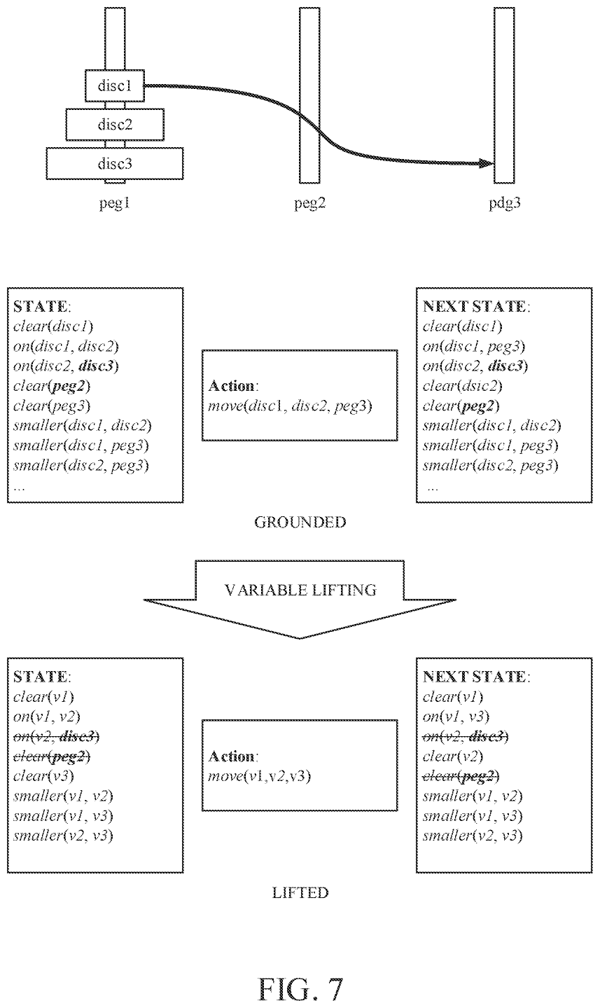

FIG. 7 illustrates a schematic of variable lifting that converts a grounded state representation into a lifted state representation. FIG. 7 describes an exemplary action ‘move (disc1, disc2, peg3)’ directing to move the object ‘disc1’ currently on the object ‘disc2’ to the object ‘peg3’ in the problem ‘Tower of Hanoi’. Before the action (i.e., in the base state), the object ‘disc1’ is at the top (i.e., clear (disc1)) and placed on the object ‘disc2’ (i.e., on (disc1, disc2)). Also, the object peg3′ is at the top (i.e., clear (peg3)). Furthermore, there is other grounded propositions relating to at least one object other than that the action involves (e.g., clear (peg2), on (disc2, disc3), . . . ).

In the PDDL domain the operator is defined to have one or more parameters and the operator becomes an action once the one or more parameters are grounded on one or more objects. The intuition is that this operator representation contains general model knowledge, whereas actions would merely inform about the current state.

In the variable lifting process, the variable lifting module 158 is configured to obtain the one or more objects in the action (i.e., disc1, disc2, and peg3 in the example shown in FIG. 7) for each training example in the set D. The variable lifting module 158 is also configured to discard one or more state propositions relating to at least one object other than the one or more objects of the action (e.g., peg2, disc3 in this example). In the training example shown in FIG. 7, the state propositions ‘clear (peg2)’ and ‘on (disc2, disc3)’ are discarded since these propositions involves irrelevant object (peg2, disc3) that the action does not involves, and is non-informative propositions. The variable lifting module 158 is further configured to replace each real object (i.e., disc1, disc2, peg3 in this example) in each remaining state proposition with an abstract variable (specifying only their index in the action such as v1, v2, v3) corresponding one of the parameters (e.g., a, b, c) of the operator.

By performing the variable lifting, every object that the action is grounded on is converted into an abstract variable. The propositions related to irrelevant objects are discarded, thereby reducing the number of propositions as shown by the strikethrough in the bottom of FIG. 7. Note that the state after the variable lifting may also be defined as a conjunction of Boolean value of every proposition that is lifted from actual objects and related to merely the one or more objects in the action (e.g., clear (v1), clear (v3), on (v1, v2) . . . ).

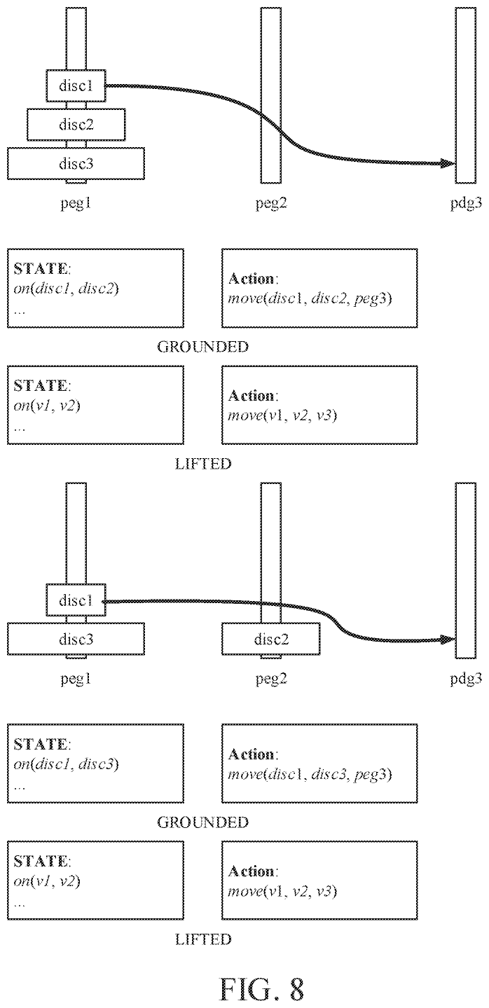

FIG. 8 illustrates examples of variable lifting to a pair of a state and an action. As shown in FIG. 8, two different propositions (e.g., ‘on (disc1, disc2)’ for an action ‘move (disc1, disc2, peg3)’ and (e.g., ‘on (disc1, disc3)’ for an action ‘move (disc1, disc3, peg3)’) can appear similar once object-specific details are abstracted. Thus, data efficiency and consistency to unseen states is expected to be improved. Only the state before the action (i.e., bases state) has been described, however the same may apply to the next state after the action.

The model 170 to be trained becomes smaller since a subset of the state is kept, meaning the input has less depths. Also, since object-specific details are abstracted and two similar situations but with different objects or state still appear the same, the training of the model 170 requires less examples, this can help generalization to some unseen cases. Variable lifting masks all specificity, meaning that the correct output can be statistically inferred. Grounding would lead overfitting and the model trained without variable lifting would try to imitate the noise. Hence, explicitly operating on lifted states would improve aspects, including generalizability and resistant to noisy states.

Referring back to FIG. 3, the operator learning module 156 may further include the effect label computing module 160. The effect label computing module 160 is configured to compute one or more effect labels used for training the model 170, for at least each valid example in the set of examples D. Each effect label indicates whether a corresponding lifted proposition changes (e.g., becomes true or false) or not (e.g., does not change) before and after the action. Computing of the one or more effect labels will be described in more detail later.

The operator learning module 156 shown in FIG. 3 may also include the validity label computing module 162. The validity label computing module 162 is configured to compute a validity label used for training the model 170, for each example in the set of examples D. In a particular embodiment, the validity label indicates whether the action is valid for the base sate or not (i.e., invalid). Computing of the validity label will be described in more detail later.

The operator learning module 156 may further include the model training module 164. The model training module 164 is configured to train the model 170 by using the set of training examples D with the validity label computed by the validity label computing module 162 and the one or more effect labels computed by the effect label computing module 160. The model 170 trained by the model training module 164 is configured to receive an input state and a representation of an input action or operator and output validity of the input action for the input state and an effect vector of the input action. The validity may a real number in the interval [0,1] and indicates predicted validity of the input action for the input state. Each element in the effect vector indicates whether a corresponding lifted proposition is predicted to changes or not. Examples of architectures of the model 170 may include, but is not limited to, a neural network model, a logistic regression model, to name but a few. Training of the model 170 and detailed architecture of the model 170 will be described in more detail later.

The operator learning module 156 may also include the precondition computing module 166. The precondition computing module 166 is configured to compute the precondition of the operator based on the model 170 trained by the model training module 164. The precondition computing module 166 is also configured to output the precondition in a format of an appropriate planning language such as PDDL by converting the lifted representation into a textual format.

The operator learning module 156 may also include the effect computing module 168. The effect computing module 168 is configured to compute the effect of the operator by using the model 170 trained by the model training module 164. The effect computing module 168 is configured further to output the effect of the operator in a format of an appropriate planning language such as PDDL by converting the lifted representation into a textual format.

In one or more embodiments, each of the modules 130, 150, 180 shown in FIG. 1, the modules 152, 156, 184, 186 shown in FIG. 2 and the modules 158, 160, 162, 164, 168 shown in FIG. 3 may be implemented as a software module including program instructions and/or data structures in conjunction with hardware components such as a processor, a memory, etc.; as a hardware module including electronic circuitry; or as a combination thereof.

These modules may be implemented on a single computer device such as a personal computer and a server machine or over a plurality of computer devices in a distributed manner such as a computer cluster of computer devices, client-server system, cloud computing system, edge computing system, etc.

The data collection store 154 and a storage for the lifted operator 182 (including the precondition 172 and the effect 174) and a storage for the parameters of the model 170 may be provided by using any internal or external storage device or medium, to which processing circuity of a computer system implementing the operator learning module 156 is operatively coupled.

Note that in the described embodiment the planner 184 is described to be built in the testing agent 180 in a context of the model-based reinforcement learning. However, the planner 184 may be used for solving the (classical) planning problem, apart from reinforcement learning.

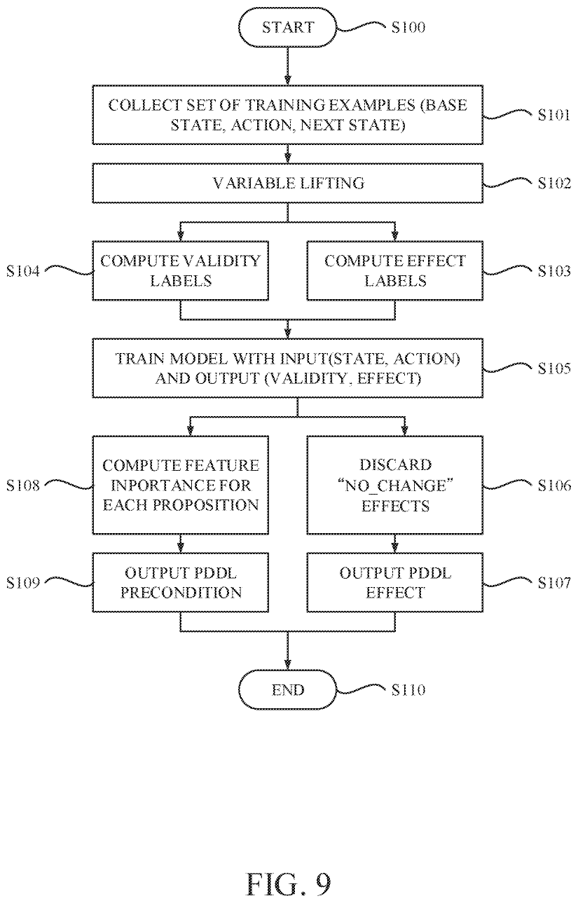

Hereinafter, with reference to FIG. 9, a process for inferring a lifted operator for a planning problem according to an exemplary embodiment of the present invention is described. FIG. 9 shows a flowchart depicting the process for inferring the lifted operator. Note that the process shown in FIG. 9 may be performed by processing circuitry such as a processing unit of a computer system that implements the operator learning module 156 and its sub-modules 158-168 shown in FIG. 3.

The process shown in FIG. 9 may begin at step S100 in response to receiving a request for the operator learning process from an operator, for instance. However, the process may begin in response to any event, including a trigger event, an implicit request, a timer, etc.

At step S101, the processing unit may collect a set of training examples (D={(s, a, s′)}) by interacting with an environment 110 in a manner based on an exploration policy (π(a|s)). Acquisition of each training example t is done by taking an action (a) in a base state (s) and receiving a result of the action (a) to obtain a next state (s′). Each training example includes a triplet of the base state (s) before the action (a), the action (a) and the next state (s′) after performing the action (a). In a particular embodiment, to collect a set of N training examples, the processing unit may start an episode from a random initial state, take and execute a random action, and store the previous state, the new state and the random action until N training examples are obtained. If the system reaches the goal state, the processing unit may continue from a new random initial state.

At step S102, the processing unit may perform variable lifting to the set of training examples D as described with FIG. 7.

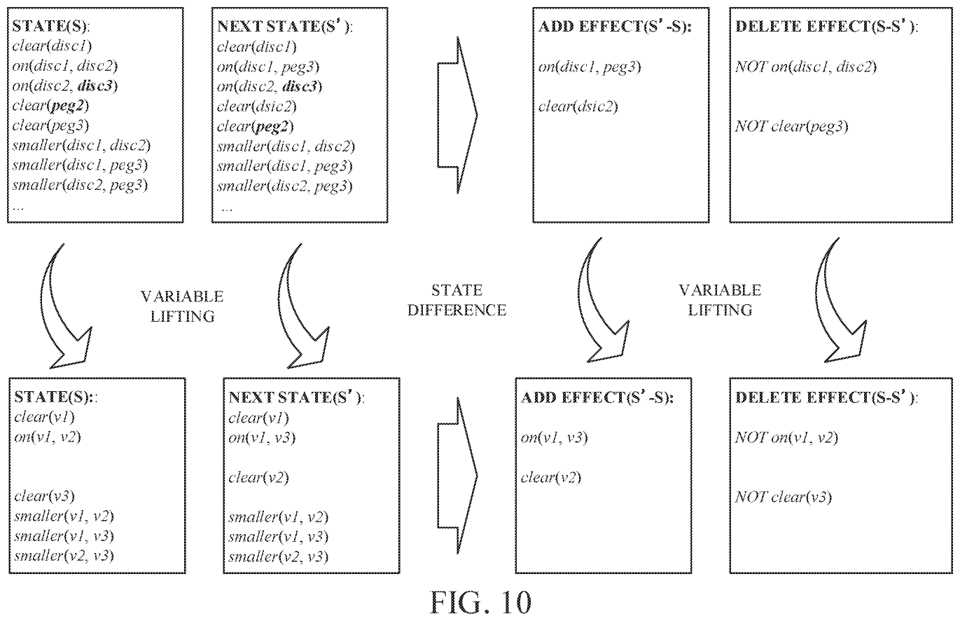

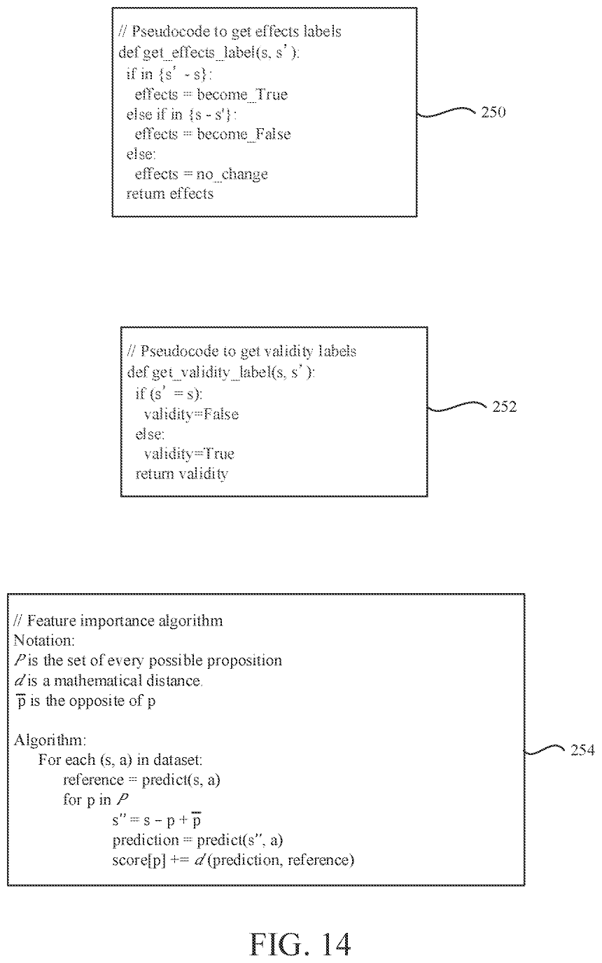

At step S103, the processing unit may compute one or more effect labels for each example in the set of training examples D based on state difference. To obtain effect labels, it is merely needed to find what has changed in the state before and after the action. FIG. 10 illustrates a schematic of a way of computing one or more effect labels with variable lifting according to an exemplary embodiment of the present invention. As shown in FIG. 10, in the step S103, the processing unit may obtain the new true propositions (add effect) by subtracting the base state from the next state (s′−s). The processing unit may also obtain the new false propositions (delete effect) by subtracting the next state from the base state (s−s′). In a particular embodiment, each effect label indicates that a corresponding possible proposition becomes true (add effect) or false (delete effect) or does not change(no effect). FIG. 14 illustrates a pseudo-code 250 for computing the effect labels.

Although in the described embodiment the variable lifting is performed before the computing of the effect labels, the process sequence of the variable lifting, and the computing of the state difference is not limited. In other embodiment, the variable lifting may be applied to the result of the state differences (s−s′ and s′−s) in the grounded state representation as shown in FIG. 10. Hence, performing variable lifting in relation to the set of training examples may include a case of applying variable lifting directly to the set of training examples and a case of applying variable lifting to the calculation results of the state difference based on the set of training examples.

Referring back to FIG. 9, at step S104, the processing unit may compute a validity label as a precondition pseudo-label for each example in the set of training examples D. Since the execution of the valid action results in a state change, so if the effects obtained at the step S103 is empty, this means the state does not change before and after the action and the training example is invalid example. In the step 104, the processing unit may label the training example as ‘invalid’ if the state difference or the effects obtained at step S103 is empty, otherwise label the training example as ‘valid’. FIG. 14 illustrates a pseudo-code 252 for computing validity label.

At step S105, the processing unit may train a model 170 by using the set of examples D with the validity label computed at step S104 and the one or more effect labels computed at step S103. The model 170 trained at step 105 is configured to receive a state (input state) and a representation of an action (input action) and output the validity of the input action for the input state and the effect vector of the input action.

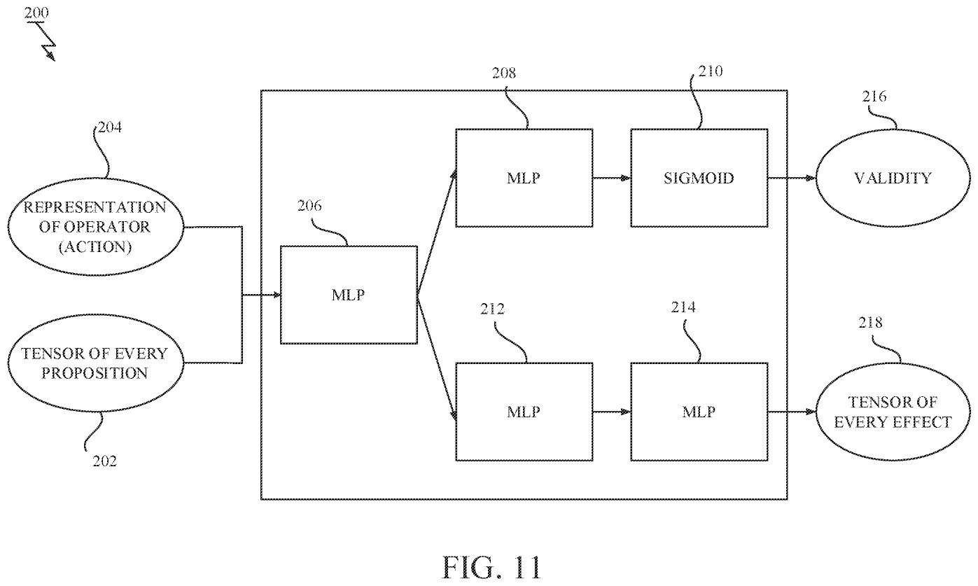

FIG. 11 illustrates an example architecture of the model 170 trained by the process for inferring the lifted operator according to the exemplary embodiment of the present invention. The architecture 200 of the model 170 includes an input layer (202, 204) and an output layer (216, 218), intermediate multilayer perceptrons (MLPs) 206, 208, 212, 214 and a sigmoid layer 210.

The input layer may receive the input state 202 and the representation of the input action 204. In a particular embodiment, the input state 202 may be Boolean value of every proposition for the lifted state and the representation of the input action 204 is one-hot encoding of the action.

In the described embodiment, the model 170 is configured to output two types of outputs, including the validity 216 and the effect vector 218. The validity is output of a binary classifier via the sigmoid layer 210 with a sigmoid activation function that converts a real valued variable into a probability. The effect vector 218 corresponds to the effect labels and indicates for each possible proposition one of three classes: ‘It becomes true’, ‘It becomes false’, ‘It doesn't change’.

The first MLP 206 is a shared layer connected to the input layer 202 204 and both following two task-specific networks. The second MLP 208 is a task-specific layer for inferring the validity of the input action for the input state. The third and fourth MPLs 212, 214 are task-specific layers for inferring for the effect of the input action.

In the described embodiment, the model 170 may be trained jointly with the validity as a target for a first output and the effect vector as a target for a second output. To train the model 170, the processing unit may apply gradient-based learning.

Note that in the described embodiment a model for inferring the validity and a model for inferring the effects are jointly learned. However, in other embodiment, a model for inferring the validity may be separated from a model for inferring the effect., and these models may be trained separately. In the case of separating the model, the MLP 206 of the model 170 shown in FIG. 11 may be replicated such that the two parts (one part 206, 208 and 210 and other part 206, 212 and 214) can become separated. In other embodiment, the process at the step S105 may be divided into two training process. In the first training process 105A, the processing unit may train a first model 170A by using the set of training examples D with the validity label computed at step S 104 such that the first model 170A is configured to output the validity of the input action for the input state as a binary classifier. In the second training process 105B, the processing unit may train a second model 170B by using the set of training examples D with the one or more effect labels computed at step S103 such that the second model 170B is configured to output the effect vector of the input action as denoiser.

Also note that the architecture shown in FIG. 11 is merely an example and in other embodiment any known architecture of the neural networks can be employed for the model 170. For instance, LNNs (Logical Neural Networks), which is better suited to logical representation, may be contemplated as the architectures of the model 170. Also, the input state 202 has been described to include Boolean value of every proposition for the lifted state. However, the input state 202 for the model 170 is not limited to the lifted state. In other embodiment, the grounded state or even mixed state (a combination of lifted and grounded representations) may be contemplated. Providing the grounded states is expected to show a benefit especially when more noise is added.

Referring back to FIG. 9, at step S106, the processing unit may discard the effect proposition having ‘no_change’ label based on the trained model 170 to compute the effect of the operator. In a particular embodiment, this step may include inputting the input state and the representation of the input action of the valid examples into the model 170, obtaining the result of predicted effect propositions and discarding the effect propositions frequently having ‘no_change’ label (more than predetermined threshold). At step S107, the processing unit may output the effect of the operator. The model 170 acts as a denoiser and the output of the trained model 170 can be used to find the most likely effects. Inputting the relevant part of the state is expected to help the model 170 recover from the noise. This also serves the purpose of allowing to predict the preconditions.

Note that these state differences are exactly the effect of the action in the case of no noise. In the case of no noise if the variable lifting is applied to the difference between the base state and next state grounded on the actual objects, the exact correct operator's effects can be obtained. This means that in the absence of noise only a single valid action is required to learn them. However, lifting the effects of a single example will no longer work if there is noise, because the found effects would be inexact. Instead of taking the results for a single example, in the described embodiment, the entire set of examples D are used to train the model 170 and the trained model 170 is used to find for the most likely correct answer.

At step S108, the processing unit may compute feature importance for each proposition based on the model 170 to compute the precondition of the operator.

In the step S108, the processing unit may compute feature importance of each lifted proposition based on the model 170 and enumerate a list of lifted propositions that satisfy criteria with respect to the feature importance as the precondition of the operator. In a particular embodiment, thresholding may be used as the criteria with respect to the feature importance.

FIG. 14 illustrates a pseudo-code 254 for performing feature importance in order to obtain the preconditions of the operator. As shown in the pseudo code 254 of FIG. 14, when computing the feature importance, the processing unit may calculate, for each training examples in the set D, validity of the action for the base state (e.g., predict (s, a)). The processing unit may generate, for each lifted proposition p (p is a member of a set of every possible proposition P) a test state (s″) based on the base state (s) by flipping the lifted proposition of interest p in the base state (s″=s−p if p is in s, and s″=s+p if p is not in s). The processing unit may calculate validity of the test state (e.g., predict (s″, a)); and score the lifted proposition (p) by comparing the validity between the base state and the test state (e.g., score[p]=+d (predict (s,a), predict (s′, a))). The function predict (x, y) is the validity prediction of an action y for state x by the model 170. The function d (x, y) may be a distance function measuring mathematical distance between x and y. Note that the dataset used to compute the feature importance based on the trained model 170 may limit to the valid examples, that is predicted to have validity above a predetermined threshold (e.g., predict (s, a)>0.5).

Also note that in a particular embodiment where the grounded state is used as the input for the model 170, the variable lifting may be performed before the feature importance algorithm. Since each grounded input has a corresponding lifted version, it is only needed to keep track of the correspondence such that the model 170 can be used with the grounded state inputs but the feature importance tests can be done as if the state input are lifted propositions that can be outputted as preconditions.

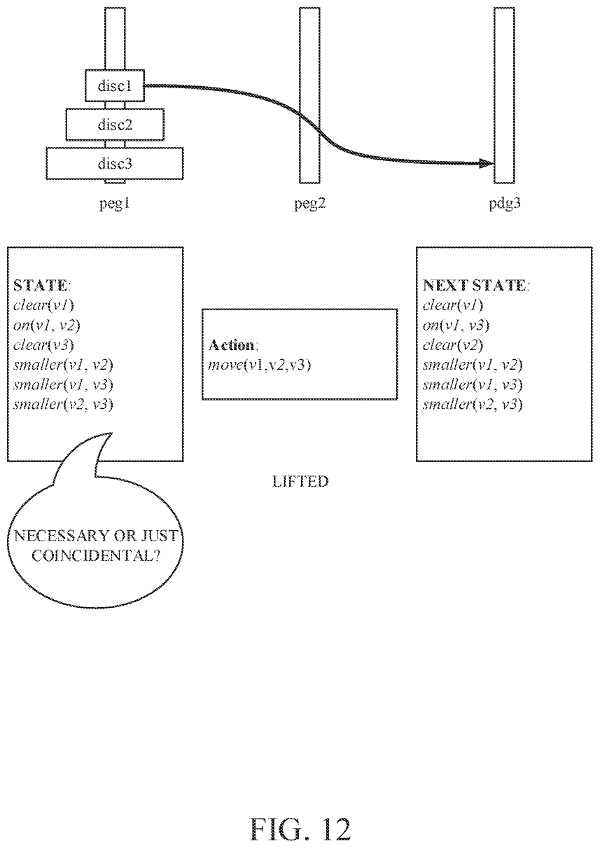

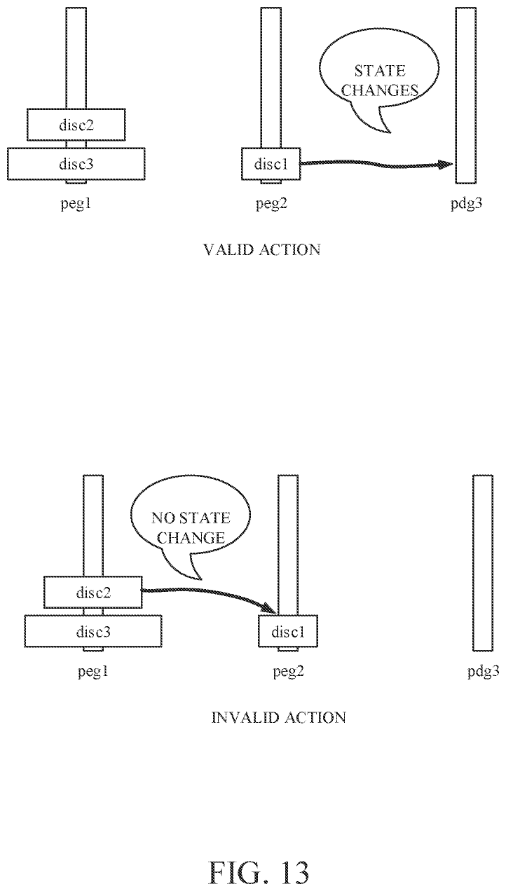

FIG. 12 illustrates a schematic of precondition of an operator in a lifted representation in the problem ‘Tower of Hanoi’. FIG. 13 illustrates examples of valid and invalid action in the problem ‘Tower of Hanoi’ in a PDDL format. With reference FIG. 12 and FIG. 13, learning of the operator's precondition will be described in more detail.

If an action is tried and the preconditions are not met, the action is considered invalid and would not have any effect as shown in FIG. 13. This gives information about what the preconditions are, and in case of a valid action, this can lead to obtaining the effects.

Consider a valid triplet (s, a, s′) and assume first the state obtained are perfectly correct (i.e., in the absence of noise). The preconditions of the action a are the Boolean values of the propositions from the base state s that are needed to be valid. The task is to find which of the propositions in the base states are necessary, and which are just coincidental. For instance, in the situation shown in FIG. 12 in the problem ‘Tower of Hanoi’, the proposition ‘smaller(v2, v3)’ is known to be not a precondition. To discriminate the necessary proposition and the coincidental precondition that appear in the action a, consider an operator w, and P denotes the set of Boolean value of every possible proposition, and pr be the set of every preconditions of the operator w, and i′ represents the subset of valid triplets whose actions are grounded from w, by the definition of the precondition, it comes:

∀p∈p,p∈pr⇒∀(s,a,s′)∈V_{w},p∈s,

and by contraposition:

∀p∈P,∃(s,a,s′)∈V_{w}|p∈s⇒p∉pr.

Essentially, this means if a valid triplet in which state a proposition p is not can be found in the valid triplet this proposition p is not a precondition of the action pr. It comes that a precondition is the intersection of the lifted propositions in the base state in all the valid triplets of the dataset. Given a diverse enough dataset, this allows the finding of working operators' preconditions. However, in the presence of noise, the base state of the triplet may miss a proposition that is actually a precondition when the noise removed it. Thus, instead of considering that the preconditions are the propositions present in every valid triplet's states, it considers those present in most valid triplets' states.

Intuitively, there can be a benefit in using invalid triplets as well, as it could be used to remove spurious propositions that are actually decorrelated to the validity of an action. Thus, the model 170 (more specifically, a binary classifier) is trained to predict an action validity from the state and action inputs by using the set of training examples, which includes both valid and invalid examples. Obtaining the preconditions can be trimmed down to finding which propositions (or neural network features) are responsible for the discrimination between a valid and an invalid example. As described above, variation of the Feature Importance method is used to attribute an importance score to each proposition, and every proposition above a certain threshold may be treated as a precondition for an operator.

At step S109, the processing unit may output the precondition of the operator based on the model. Then, the process ends at step S110.

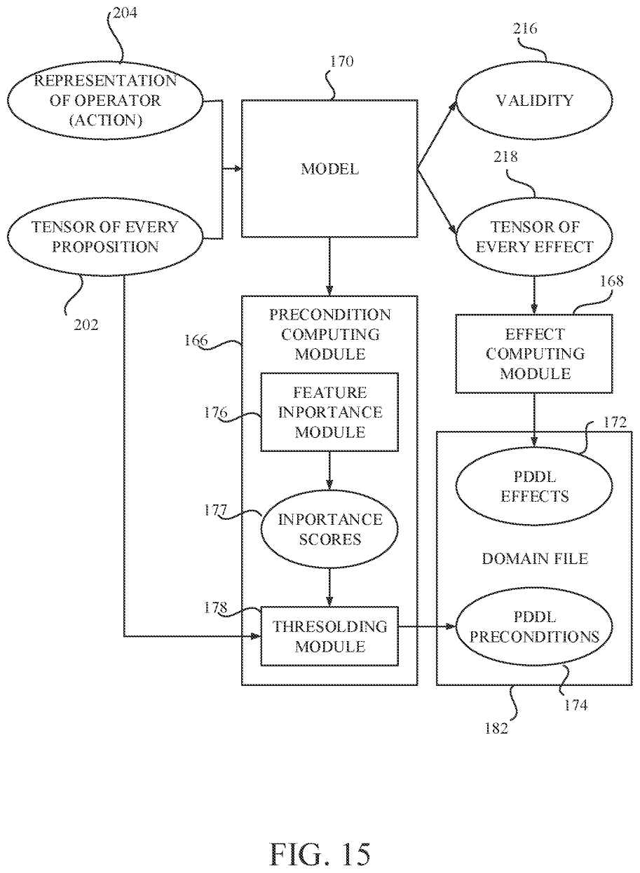

FIG. 15 summarizes overall flow to obtain a precondition and an effect of an operator from a set of training examples in a reinforcement learning system according to an exemplary embodiment of the present invention.

As shown in FIG. 15, the effect computing module 168 is configured to compute the effect of the operator by using the effect vector 218 of the trained model 170. The effect computing module 168 is configured to output the effect of the operator in a format of PDDL, for instance.

The precondition computing module 166 may include a feature importance module 176 and a thresholding module 178 as its submodule. The feature importance module 176 is configured to compute the feature importance score 177 for every lifted proposition. The thresholding module 178 is configured to enumerate a list of lifted propositions having feature importance scores above a predetermine threshold. The precondition computing module 166 is configured to output the precondition in a format of PDDL, for instance.

PDDL effect 172 and PDDL precondition 174 composes a domain file of the PDDL planner as the lifted operator 182.

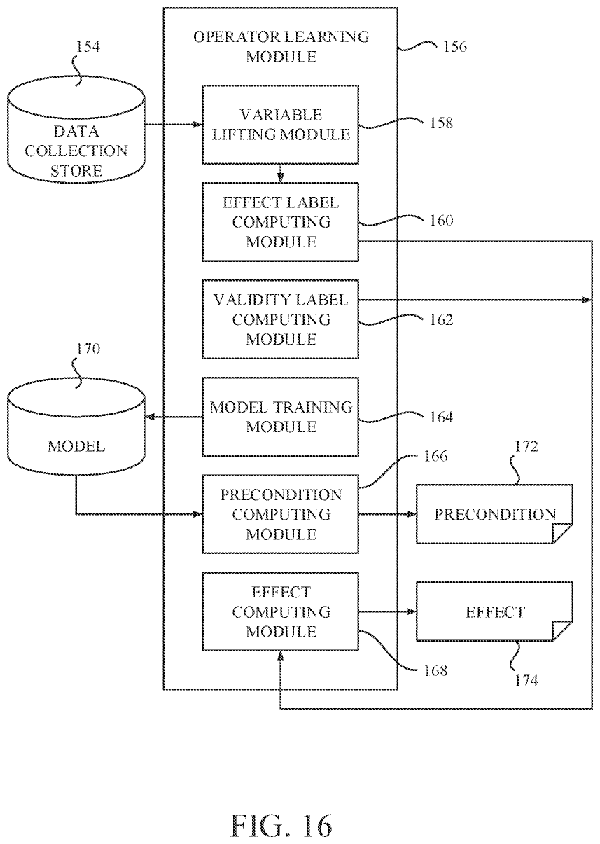

In the aforementioned embodiments, the effect has been described to be computed by using the model 170 trained with the one or more effect labels. However, in other embodiment, the effect can be obtained by an even more simple method. FIG. 16 illustrates a schematic of an operator learning module according to other exemplary embodiment of the present invention where the effect of the operator is estimated without using the trained model 170.

With reference to FIG. 16, a schematic of the operator learning module 156 according to the other exemplary embodiment of the present invention is described. The operator learning module 156 shown in FIG. 16 has almost same functionality as that shown in FIG. 3, unless otherwise noted. The operator learning module 156 according to the other embodiment may include a variable lifting module 158; an effect label computing module 160; a validity label computing module 162; a model training module 164 for training a model 170; and a precondition computing module 166 for computing the precondition of the operator based on the trained model 170; as similar to the embodiment shown in FIG. 3. The operator learning module 156 shown in FIG. 16 may also include an effect computing module 168. However, the effect computing module 168 according to the other embodiment is configured to compute the effect without using the trained model 170.

In the other embodiment, the set of training examples are subjected to perform the variable lifting, followed by effect label computing and the validity label computing. The effect label computing module 160 is configured to calculate a statistic of each of the effect statement over the valid examples in the set of examples D to obtain the effect of the operator. As mentioned above, in the absence of the noise if the variable lifting is applied to the difference between the base state and next state grounded on the actual objects, the exact correct operator's effects can be obtained. Even though in the presence of noise, a simple strategy such as calculating of a statistic is expected to be work. In a particular embodiment, a statistic such as averaging of those effects found from multiple triplets can be used.

Hereinafter, the advantages of the system and process for inferring the lifted operator according to one or more embodiment of the present invention will be described by referring to experimental results with a simple example of the problem ‘Tower of Hanoi’, which can be implemented by using the PDDLgym. The PDDLgym is a framework that automatically constructs OpenAI Gym environments from PDDL domains and problems. The main task of the operator learning was to learn an equivalent representation of the handcrafted operator of the problem ‘Tower of Hanoi’ from the set of training examples acquired by interacting with the environment that implements the problem ‘Tower of Hanoi’ by the PDDL gym.

Recovering of Operator's effect and preconditions: For the problem ‘Tower of Hanoi’, with lower noise values a lifted operator model that produces optimal plans with PDDL planners was able to be recovered by the operator learning method shown in FIG. 9. Most runs resulted in an operator model that is similar to the handcrafted version.

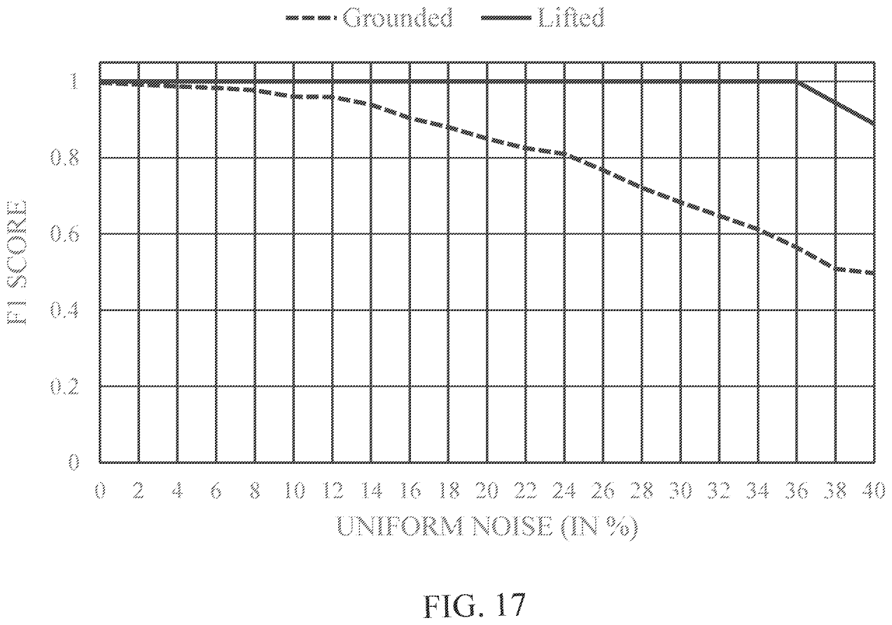

Advantage of lifted representation in comparison with grounded representation: With reference to FIG. 17, advantage of variable lifting in comparison with grounded state representation is described. FIG. 17 shows a graph indicating evolution of grounded and lifted F1 score with noise. In this experiment, a lifted model and a grounded model were trained on 2000 triplets, roughly 10% of which are valid, with uniform noises where x (x axis of the graph in FIG. 17) percent chance that each proposition is toggled in order to simulate the results of the semantic parser 130. The task trained on was a state transition (i.e., predicting merely the effects), meaning that by inputting a state and an action the model trained to output the next state. The F1 score between the prediction of the next state and the ground truth for 1000 valid triplets are shown in FIG. 17. The results in FIG. 17 show that, in absence of noise, both models have similar capabilities, however, the grounded model will fit to the noise, making it very little resilient.

Result for effect learning: Table 1 shows results for the solving rate while predicting operator's effect with uniform noise. In this experiment, a lifted model was trained on 4000 examples. The score is the solving ratio for 20 runs. In Table 1, the averaging method considered as effects that the propositions seen in a majority of effects of the valid examples. Since those effects are the difference between a state after and before an action, both states are affected by noise. Note that the solving rate of the planner using effects learned from 4000 noisy triplets and ground-truth preconditions to complete the domain knowledge is reported.

TABLE 1

| Noise | 0.25 | 0.26 | 0.27 | 0.28 | 0.29 | 0.3 |
|---|---|---|---|---|---|---|
| Averaging | 95% | 75% | 60% | 25% | 10% | 0% |
| Neural Network | 70% | 75% | 55% | 60% | 60% | 50% |

The learning method with neural network seems able to learn on labels more often wrong than right. There are two phenomenon that could explain that: The effects being a logical form, its propositions are not completely decorrelated from each other. It is possible the network learn that some propositions have to be put together. The learning method has in its inputs the previous state, which might help the network to learn some noise control in the very noisy effects, from the less noised previous state.

Result for precondition learning: As described above, when assuming the state are perfectly correct., if a valid triplet in which state a certain proposition is not found, this proposition is not a precondition of the action. It comes that a precondition is the intersection of the lifted propositions in all the valid triplets' state of the dataset. When noisy states are considered, instead of considering that the preconditions are the propositions present in every valid triplet's states, those present in most valid triplets' states is considered. One way for considering the most valid triplet's state is defining a cutoff proportion p_{cutoff}, in which the Boolean value of a proposition seen in more than p_{cutoff} of the triplets in the set of the training examples is considered as a precondition.

However, the intersection method for the preconditions has a major flaw. There can be situations where no value of p_{cutoff} could solve the problem. If a proposition p is very frequent, but not a precondition of an operator w, it could still be seen in more than p_{cutoff} of the valid triplets with w and thus be considered by the simple insertion method as a precondition. Increasing the cutoff proportion can fix this problem, however, at the same time reduces noise resilience to false negative.

In order to test this inability, an example of a proposition, not belonging to the preconditions of an operator, but still very frequent is required. Hence, a noise specifically to simulate those conditions was designed. In this noise, all possible propositions having ‘smaller’ predicate are set to true randomly with a probability of 0.6 while the other statements remain the same. This makes that in a lifted valid example of the action, some ‘smaller’ propositions will appear very often, regardless of their precondition status. A cutoff value for the intersection method of 0.75 was used. The same 4000 training examples were used for both the intersection method and the learning method to learn the preconditions and completed the domain knowledge with ground-truth effects. The solving rate on 20 games was reported. The results are that the learning method could solve 85% of the games, while the intersection method had a solving rate of only 10%.

The success of the binary classifier may be explainable by these propositions being decorrelated with the validity of an action, even when very frequent, and this translates in having a low feature importance score. Fundamentally, the intersection method fails because it does not use invalid actions to gather knowledge.

It was demonstrated that the variable lifting can help an effective learning of the operators, especially when considering noisy data. It was also demonstrated that the preconditions learning in a novel way, using Feature Importance, has the ability to disambiguate preconditions from other frequent propositions, which the most related methods fail to do.

According to the aforementioned embodiments, there is provided a method, a computer system and a computer program product capable of inferring an operator for a planning problem from a set of examples including results of performing actions even in the presence of noise.

Although the advantages obtained with respect to the one or more specific embodiments according to the present invention have been described, it should be understood that some embodiments may not have these potential advantages, and these potential advantages are not necessarily required of all embodiments.

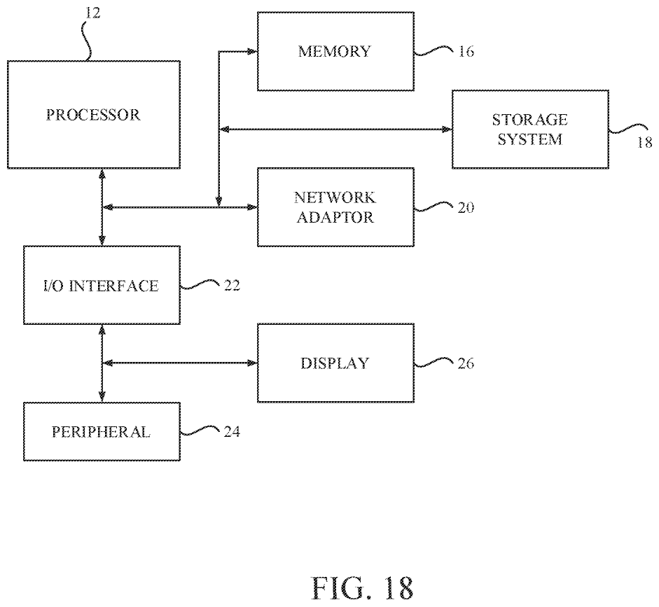

Computer Hardware Component: Referring now to FIG. 18, a schematic of an example of a computer system 10, which can be used for implementing the operator learning module 156, is shown. The computer system 10 shown in FIG. 18 is implemented as computer system. The computer system 10 is only one example of a suitable processing device and is not intended to suggest any limitation as to the scope of use or functionality of embodiments of the invention described herein. Regardless, the computer system 10 is capable of being implemented and/or performing any of the functionality set forth hereinabove.

The computer system 10 is operational with numerous other general purposes or special purpose computing system environments or configurations. Examples of well-known computing systems, environments, and/or configurations that may be suitable for use with the computer system 10 include, but are not limited to, personal computer systems, server computer systems, thin clients, thick clients, hand-held or laptop devices, in-vehicle devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 10 may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 18, the computer system 10 is shown in the form of a general-purpose computing device. The components of the computer system 10 may include, but are not limited to, a processor (or processing unit) 12 and a memory 16 coupled to the processor 12 by a bus including a memory bus or memory controller, and a processor or local bus using any of a variety of bus architectures.

The computer system 10 typically includes a variety of computer system readable media. Such media may be any available media that is accessible by the computer system 10, and it includes both volatile and non-volatile media, removable and non-removable media.

The memory 16 can include computer system readable media in the form of volatile memory, such as random access memory (RAM). The computer system 10 may further include other removable/non-removable, volatile/non-volatile computer system storage media. By way of example only, the storage system 18 can be provided for reading from and writing to a non-removable, non-volatile magnetic media. As will be further depicted and described below, the storage system 18 may include at least one program product having a set (e.g., at least one) of program modules that are configured to carry out the functions of embodiments of the invention.

Program/utility, having a set (at least one) of program modules, may be stored in the storage system 18 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

The computer system 10 may also communicate with one or more peripherals 24 such as a keyboard, a pointing device, a car navigation system, an audio system, etc.; a display 26; one or more devices that enable a user to interact with the computer system 10; and/or any devices (e.g., network card, modem, etc.) that enable the computer system 10 to communicate with one or more other computing devices. Such communication can occur via Input/Output (I/O) interfaces 22. Still yet, the computer system 10 can communicate with one or more networks such as a local area network (LAN), a general wide area network (WAN), and/or a public network (e.g., the Internet) via the network adapter 20. As depicted, the network adapter 20 communicates with the other components of the computer system 10 via bus. It should be understood that although not shown, other hardware and/or software components could be used in conjunction with the computer system 10. Examples, include, but are not limited to, microcode, device drivers, redundant processing units, external disk drive arrays, RAID systems, tape drives, and data archival storage systems, etc.

Computer Program Implementation: The present invention may be a computer system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, steps, layers, elements, and/or components, but do not preclude the presence or addition of one or more other features, steps, layers, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more aspects of the present invention has been presented for purposes of illustration and description, but is not intended to be exhaustive or limited to the invention in the form disclosed.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for inferring an operator comprising a precondition and an effect of the operator for a planning problem, the method comprising:
preparing, by one or more computer processors, a set of examples each including a base state, an action and a next state after performing the action in the base state;
performing, by one or more computer processors, variable lifting in relation to the set of examples;
computing, by one or more computer processors, a validity label for each example in the set of examples;
training, by one or more computer processors, a model configured to receive an input state and a representation of an input action and output at least validity of the input action for the input state, by using the set of examples with the validity label;
outputting, by one or more computer processors, the precondition of the operator based on the model; and
outputting, by one or more computer processors, the effect of the operator.

2. The computer-implemented method of claim 1, wherein preparing the set of examples comprises:
interacting, by one or more computer processors, with an environment by taking the action in the base state and receiving a result of the action to obtain the next state in a manner based on an exploration policy.

3. The computer-implemented method of claim 1, further comprising:
computing, by one or more computer processors, based on the model, importance of each lifted proposition relating to a state; and
enumerating, by one or more computer processors, a list of lifted propositions satisfying criteria with respect to the importance as the precondition of the operator.

4. The computer-implemented method of claim 3 wherein computing the importance of each lifted proposition comprises:
generating, by one or more computer processors, a test state based on the base state by flipping the lifted proposition;
calculating, by one or more computer processors, validity of the action for the base state and the test state; and
scoring, by one or more computer processors, the lifted proposition by comparing the validity between the base state and the test state.

5. The computer-implemented method of claim 1, wherein training the model comprises:
computing, by one or more computer processors, one or more effect labels for each valid example in the set of examples; and
training, by one or more computer processors, the model jointly with the validity as a target for a first output and an effect vector as a target for a second output by using further the one or more effect labels for each valid example, each element in the effect vector indicating whether a corresponding lifted proposition changes or not, the effect of the operator being calculated by using the model.

6. The computer-implemented method of claim 1, further comprising:
computing, by one or more computer processors, one or more effect labels for each valid example in the set of examples; and
training, by one or more computer processors, a second model configured to receive the input state and the representation of the input action and output an effect vector, by using the set of examples with the one or more effect labels, each element in the effect vector indicating whether a corresponding lifted proposition changes or not, the effect of the operator being calculated by using the second model.

7. The computer-implemented method of claim 1, wherein outputting the effect of the operator comprises:
calculating, by one or more computer processors, one or more effect labels for each valid example in the set of examples; and
calculating, by one or more computer processors, a statistics of each of the one or more effect labels over the valid examples in the set of examples to obtain the effect of the operator.

8. The computer-implemented method of claim 1, wherein the operator has one or more parameters and the operator becomes the action once the one or more parameters are grounded on one or more objects, performing variable lifting comprising:
obtaining, by one or more computer processors, the one or more objects in the action for each example in the set of examples;
discarding, by one or more computer processors, one or more state propositions relating to other than the one or more objects of the action; and
replacing, by one or more computer processors, each object in each remaining state proposition with an abstract variable corresponding one of the one or more parameters.

9. The computer-implemented method of claim 1, wherein the precondition comprises a list of lifted propositions to be valid to perform an action of the operator and the effect includes a list of changes in a lifted state after performing an action of the operator.

10. The computer-implemented method of claim 1, wherein the precondition and the effect of the operator are used by a planner for planning a sequence of actions.

11. The computer-implemented method of claim 10, wherein the planner is used by an agent in a model-based reinforcement learning system where the agent takes an action inferred by the planner and receives a state generated by a semantic parser in a logical form

12. A computer system for inferring an operator comprising a precondition and an effect of the operator for a planning problem comprising:
one or more computer processors;
one or more computer readable storage media; and
program instructions stored on the computer readable storage media for execution by at least one of the one or more processors, the stored program instructions comprising:
program instructions to prepare a set of examples each including a base state, an action and a next state after performing the action in the base state;
program instructions to perform variable lifting in relation to the set of examples;
program instructions to compute a validity label for each example in the set of examples;
program instructions to train a model configured to receive an input state and a representation of an input action and output at least validity of the input action for the input state, by using the set of examples with the validity label;
program instructions to output the precondition of the operator based on the model; and
program instructions to output the effect of the operator.

13. The computer system of claim 12, wherein the program instructions stored, on the one or more computer readable storage media, further comprise:
program instructions to interact with an environment by taking the action in the base state and receiving a result of the action to obtain the next state in a manner based on an exploration policy in order to prepare the set of examples.

14. The computer system of claim 12, wherein the program instructions stored, on the one or more computer readable storage media, further comprise:
program instructions to compute, based on the model, importance of each lifted proposition relating to a state; and
program instructions to enumerate a list of lifted propositions satisfying criteria with respect to the importance as the precondition of the operator.

15. The computer system of claim 12, wherein the program instructions, to compute the importance of each lifted proposition, comprise:
program instructions to generate a test state based on the base state by flipping the lifted proposition;
program instructions to calculate validity of the action for the base state and the test state; and
program instructions to score the lifted proposition by comparing the validity between the base state and the test state.

16. The computer system of claim 12, wherein the program instructions, to train the model, comprise:
program instructions to compute one or more effect labels for each valid example in the set of examples; and
program instructions to train the model jointly with the validity as a target for a first output and an effect vector as a target for a second output by using further the one or more effect labels for each valid example, each element in the effect vector indicating whether a corresponding lifted proposition changes or not, the effect of the operator being calculated by using the model.

17. A computer program product for inferring an operator comprising a precondition and an effect of the operator for a planning problem comprising:
one or more computer readable storage media and program instructions stored on the one or more computer readable storage media, the stored program instructions comprising:
program instructions to prepare a set of examples each including a base state, an action and a next state after performing the action in the base state;
program instructions to perform variable lifting in relation to the set of examples;
program instructions to compute a validity label for each example in the set of examples;
program instructions to train a model configured to receive an input state and a representation of an input action and output at least validity of the input action for the input state, by using the set of examples with the validity label;
program instructions to output the precondition of the operator based on the model; and
program instructions to output the effect of the operator.

18. The computer program product of claim 17, wherein the program instructions to prepare the set of examples comprise:
program instructions to interact with an environment by taking the action in the base state and receiving a result of the action to obtain the next state in a manner based on an exploration policy.

19. The computer program product of claim 17, wherein the program instructions, stored on the one or more computer readable storage media, further comprise:
program instructions to compute, based on the model, importance of each lifted proposition relating to a state; and
program instructions to enumerate a list of lifted propositions satisfying criteria with respect to the importance as the precondition of the operator.

20. The computer program product of claim 17, wherein the program instructions, stored on the one or more computer readable storage media, further comprise:
program instructions to compute one or more effect labels for each valid example in the set of examples; and
program instructions to train the model jointly with the validity as a target for a first output and an effect vector as a target for a second output by using further the one or more effect labels for each valid example, each element in the effect vector indicating whether a corresponding lifted proposition changes or not, the effect of the operator being calculated by using the model.
